(19) United States
(12) Patent Application Publication
(10) Pub. No.: US 2019/0291054 A1
(43) Pub. Date: Sep. 26, 2019

(54) COMPOSITE ION CONDUCTING MEMBRANE TUBING AND PROCESS OF MAKING SAME

(71) Applicant: Xergy Inc., Harrington, DE (US)

(72) Inventors: Bamdad Bahar, Georgetown, DE (US); Harish Opadrishta, Dover, DE (US); William Parmelee, Orleans, MA (US)

(21) Appl. No.: 16/365,401

(22) Filed: Mar. 26, 2019

Related U.S. Application Data
(60) Provisional application No. 62/648,357, filed on Mar. 26, 2018.

(51) Int. Cl. B01D 63/06; B01D 61/36; B01D 71/36; C02F 1/44

(52) U.S. Cl. CPC B01D 63/061; B01D 61/362; C02F 2103/08; C02F 1/448; B01D 71/36

(57) ABSTRACT

A composite ion conducting tube is made by wrapping a support material or ion conducting sheet to from a tube having overlaps of layers that are bonded. The ion conducting sheet or tape used to make the tube may be very thin and the tube may be formed in situ by wrapping the support material and then coating with ion conducting polymer. The ion conducting tubes may be used in a pervaporation module or desalination system. The ion conducting tubes may be spirally wrapped or longitudinally wrapped and may be very thin having a tube wall thickness of no more than 25 microns.

### CROSS REFERENCE TO RELATED APPLICATIONS

This application claims the benefit of U.S. provisional patent application No. 62/648,357, filed on Mar. 26, 2018; the entirety of which is hereby incorporated by reference herein.

### BACKGROUND OF THE INVENTION

### Field of the Invention

The present invention relates to apparatus used for drying or humidifying gases for electrochemical, medical, analytical and oil & gas applications. The process for manufacturing abovementioned apparatus is also explained

### Background

U.S. Pat. No. 4,705,543A currently assigned to Perma-Pure LLC discloses a tubular drying device comprising of a tube which transmits water and a braided netting covering the tube; the entirety of which is incorporated by reference herein.

U.S. Pat. No. 6,779,522B2 currently assigned to Perma-Pure LLC discloses a method of manufacturing a tubular drying device used for humidification or drying of patient breathing gases in the breathing lines for patient monitoring or anesthesia results; the entirety of which is incorporated by reference herein. Said device consists of thin-walled membrane tubing which transmits water, a protective outer mesh and fittings on each end. The protective outer mesh protects the thin-walled membrane tubing from damage or from contamination by skin oils during handling.

The thin-walled membrane tubing is manufactured by inserting water permeable material into a blown film extruder. Then material is then forced through concentric extruding heads. Air is blown through the center of extruding heads to create a thin-walled tube. The thin-walled tube is then converted to the hydrogen ion form, dried and bathed in methanol to be swollen. It is then manipulated into a tubular shape.

An exemplary composite ion conducting sheet comprises a support material and an ion conducting polymer attached thereto, such as by being coated onto a surface, and/or into the pores of the support material, and/or being imbibed into the pores of the support material from one side to the opposing side. A ion conducting polymer may substantially fills the pores of the support material whereby at least 90% of the porosity of the support material is filed with the ion conducting material; as determined by a density calculation of the support material and imbibed support material. A composite ion conducting sheet or tape may be impermeable, whereby it has no bulk flow of air, wherein it has a Gurley Densometer time, according to a Gurley 4340 Automatic Gurley Densometer, Gurely Precision Instrument Inc. Troy NY, of more than 200 seconds.

The thin walled tube is then inserted into a protective outer mesh. The end fittings are affixed to the assembly to create the abovementioned drying device.

U.S. Pat. No. 5,980,795A currently assigned to Gkss-Forschungszentrum Geesthacht GmbH discloses a method of producing hollow fiber polymer membranes, wherein a molten polymer charged with a gas under pressure is extruded the entirety of which is incorporated by reference herein.

The extrusion process used to manufacture PFSA (Perfluorosulfonic acid) tubes is essentially a twostep process. The extrusion process uses melt processable polymers and then goes through a post sulfonation step. The melt processable polymers that are used must be inherently strong i.e. relatively low acidity due to high equivalent weight.

U.S. Pat. Nos. 8,366,811B2, 9,067,035B2, 8,747,752B2 currently assigned to Oridion Medical (1987) Ltd. disclose dryer polymer substances adapted to pervaporate a fluid (such as water, water vapor or both) and their methods of preparation. U.S. Pat. No. 8,747,752B2 discuss a dryer polymer substance that included: a porous support member and a cross-linked co-polymer comprising a) a cationic monomer and an anionic monomer, b) a zwitterionic monomer, or a combination thereof; the entirety of which is incorporated by reference herein.

The entirety of all patents and applications in the background are hereby incorporated by reference herein.

### SUMMARY OF THE INVENTION

The invention is related to pervaporation modules comprising very thin ion conducting sheets of material generally referred to as ion conducting membrane. The ion conducting tubes are from ion conducting polymers and preferably thin composite ion conducting membranes comprising an ion conducting polymer and a support material. In an exemplary embodiment, a support material is a porous membrane, such as a porous fluoropolymer membrane, supports an ion conducting polymer to enable the composite to be very thin, such as less than 50 μm, and preferably less than 25 μm and even more preferably less than 15 μm, and even more preferably less than 10 μm. A thin composite ion conducting membrane may be made into a pervaporation tube by wrapping, either spirally or “cigarette wrap. In an exemplary embodiment, the ion conducting sheet or tape is wrapped around a mandrel to form the ion conducting tube. Note that an ion conducting sheet or tape may be wrapped any number of times, such as two or more times to produce a plurality of layers of the support material through the tube wall. An exemplary ion conducting sheet is double helically wrapped, such as around a mandrel, to form the ion conducting tube.

The wrapped composite ion conducting membrane may have bonded areas wherein at least a portion of the overlap area is bonded together, such as by being fused, or laminated, or thermally welded together, or wherein the ion conducting polymer from one layer is bonded with an ion conducting polymer layer of a second layer or with a support material of a second layer. These bonded areas may be thicker than non-bonded areas where a single layer of the ion conducting. The overlapped width of a bonded area may be fraction of the tape width, such as no more than about 30% of the tape width, no more than about 25% of the tape width, no more than about 20% of the tape width, no more than about 10% of the tape width, or even no more than about 5% of the tape width to provide a high percentage of the spiral wrapped tube 32 that is only a single layer, thereby increase the rate of transfer of ions through the tube. The bonded areas may make up some proportion of the ion conducting tube surface area, wherein the surface area is the product of the outer circumference of the tube and the length of the tube. The bonded areas may be a proportion of the tube surface area, such as no more than about 30%, no more than about 25%, no more than about 20%, no more than about 10%, or even no more than about 5%, or any range between and including the percentages provided. A low percentage bonded area may provide a higher percentage of thin ion conducting tubing and improve ion transfer and effectiveness of the system. A longitudinally wrapped tube may have a very low percentage of bonded area, as the bonded area may extend along the length and not around the tube as is the case with a spiral wrapped tube. A spiral wrapped tube may however be stronger and less prone to breaking under pressure.

According to one embodiment of the present invention, there is provided a tubular structure comprising of a porous support layer and an anionic or a cationic polymer. The tubular structures have overlapping “bonded areas”.

According to one embodiment of the present invention, the porous support layer is further reinforced with mandrel used to provide strength and rigidity. An exemplary mandrel may extend within the tube conduit or the ion conducting tube may configured within the mandrel. The mandrel may resist expansion or contraction of the ion conducting tube due to pressure difference between the outside and inside surface of the tube. An exemplary mandrel is permeable and may have apertures through the mandrel wall to enable fluid contact on both the outside and inside surfaces of the ion conducting tube.

According to one embodiment of the present invention, there is provided a process for the preparation of the membrane tubes by tape-wrapping a porous support material, such as a porous polymeric material, around a mandrel. The mandrel may then be heated, such as by being passed through a heating chamber or an infrared chamber, to fuse the wrapped support material into a continuous tubular structure. The tubular structure may then be passed through a coating process wherein the porous tube is coated with the ion conducting polymer. The assembly may then be dried, such as by being air dried or by being passed through a dryer to dry the porous tubes after the coating process. A dryer may be a radiant dryer or a forced air dryer, for example. The dried ion conducting tube may then be dipped in water and swollen, when the ion conducting polymer is hydrophilic and swell with water. The tubes may then be removed from the mandrel and dried once again back to approximately an original size. In some cases, the ion conducting tube may be left on the mandrel and the mandrel may provide support for pressure difference in use. The mandrel may also enable potting of the ion conducting tube in a module.

According to one embodiment of the present invention, a support material is wrapped around a mandrel and then coated with ion conducting material and then dried to produce a composite ion conducting tube on a mandrel. The composite ion conducting tube may be removed from the mandrel or may be used with the mandrel as a support mandrel in an application.

According to one embodiment of the present invention, a composite ion conducting sheet is wrapped around a mandrel and then bonded together, wherein the overlap areas are bonded together to form bonded areas and to form the tube. The composite ion conducting tube may be removed from the mandrel or may be used with the mandrel as a support mandrel in an application.

According to one embodiment of the present invention, a composite ion conducting sheet is wrapped around a mandrel while the ion conducting polymer is dissolved in a solvent. The wrapped mandrel may then be dried to bond the overlap areas of the wrapped support layer together. The solution of ion conducting polymer and solvent may imbibe the support material and form an air impermeable layer to form the ion conducting tube. Again, the composite ion conducting tube may be removed from the mandrel or may be used with the mandrel as a support mandrel in an application.

According to one embodiments of the present invention, there is provided a process for the preparation of tubular structure adapted to pervaporate the fluid by helically wrapping one or more membranes around a cylindrical structure and using heat or infrared radiation on the assembly to fuse the wrapped membrane tapes into a continuous cylindrical structure.

According to one embodiment of the invention, we describe a method to put structural meshes around the tubes for structural rigidity. This is accomplished by passing the structural mesh over the tube and using adhesive lined heat shrink at the ends to bond the structural mesh to the ionic tube.

According to one embodiment of the invention, we describe a method for putting fittings at the ends of the tubes. We insert rigid plastic tubing at the ends of the ionic tubing, and insert the plastic tubing into different kinds of fittings such as compression, barbed, push-to-connect, etc. We further use adhesive lined heat shrink to attach the ionic tubing to rigid plastic tubing.

The manufacturing processes described above ensure that the tubes are much thinner than those described in the prior art. The thinness of the tubes along with the greater ionic nature of the material ensures tubes which permeate water, water vapor with greater ability.

According to one embodiments of the present invention, there are provided devices, modules, which employ pervaporative tubing to dry incoming air streams for medical, analytical, electrochemical and oil and gas purposes. Several pervaporative tubes are forced into a cylindrical structure which constitutes the shell. The pervaporative tubes are capped off and then dipped into potting resin. Once, the potting resin and seals all tubes in place, the process is repeated on the other end of the tubes. Finally, the ends are capped off with front and rear headers.

The modules provide a number of key features and benefits including: Ultra-thin composites are usable to make these tubes. The tubes that are very strong, and therefore can handle a high pressure feed. Because of the combination of strength and the thin nature of the ion conducting tube, there is less resistance to permeation which enables higher performance tubular systems. Because of the ultra-thin structure, less expensive ion conducting polymer material is used to produce these tubes, therefore the units have inherently lower cost, and therefore the technology can be applied to wider range of applications beyond the current thick walled, extruded tubes that are present in the market.

The technology is ideally suited for desalination, ionic liquid desiccation, waste processing and numerous other applications. A membrane-based desalination unit utilizing the ion conducting tubes described herein may be a standalone unit which fits in a 3.048 m (10 ft) shipping container.

This technology can provide a compact, portable seawater desalination system utilizing solar energy. This is a derivative product leveraging Xergy's current program to supply the Department of Energy/U.S. Navy with a 100 gallon per day Solar Vacuum Desalination System (VD) based on its “Advanced Composite Polymer Electrolyte membranes (PEM)” which will be installed at San Clemente Island (Calif.) under DOE funding.

The core technology behind the desalination unit is explained in FIG. 1. At the heart of this technology is the heat exchanger module which exchanges heat between the incoming cold membrane circulating stream and the steam obtained from the membrane contactor.

This enables us to simultaneously condense steam as well as heat the incoming sea water feed. The membrane contactor unit is comprised of ion exchange membranes and purifies water by pervaporation to salinity levels below 60 ppm as shown in Table 1. From Table 1, we see that the moisture flux is highly dependent on the brine temperature at a fixed vacuum.

TABLE 1
Respective yield for each temperature, flux rate, final salinity and
change in salinity.

| | Water | Dura- | | | | | Salinity |
|---|---|---|---|---|---|---|---|
| Trial | temp | tion | Mass | Flux rate | Salinity | Salinity | difference |
| # | (C.) | (min) | (g) | (g/hr.m\hat{ }2) | in (%) | out (%) | (%) |
| 1 | 40 | 45 | 2.51 | 259.43 | 2.6 | 0.0033 | 99.873 |
| 2 | 58 | 45 | 23.965 | 2477.00 | 2.5 | 0.006 | 99.764 |

The pervaporation modules and pervaporation tubes comprising an ion conductive polymer and preferably a composite ion conductive membrane that is thin may be used in any of the following application, U.S. provisional patent application No. 62244709, filed on Oct. 20, 2015, U.S. provisional patent application No. 62385178 filed on Sep. 8, 2016, U.S. patent application No. 15698886 filed on Sep. 8, 2016, and U.S. provisional patent application No. 62594091, filed on Dec. 4, 2017; the entirety of each patent application is incorporated by reference herein. An exemplary ion conducting polymer in an ionomer, or proton conducting polymer, such as sulfonated tetrafluoroethylene based fluoropolymer-copolymer, as perfluorosulfonic acid.

An exemplary pervaporation tube comprises a composite ion conducting sheet, or membrane, as described in any of the embodiments herein. An exemplary pervaporation tube may be spirally wrapped or longitudinally wrapped with the composite ion conducting sheet. An exemplary pervaporation tube may be configured in a module to exchange moisture form within the tube conduit of the ion conducting tube to outside of the ion conducting tube or vice versa. A module, such as a pervaporation module may have any number of ion conducting tubes therein, such as two or more, five or more, ten or more, twenty or more and any range between and including the numbers provided. The diameter of the ion conducting tube may be small to increase the surface area exposed, such as no more than about 50 mm, no more than about 25 mm, no more than about 10 mm, no more than about 5 mm, no more than about 3 mm and any range between and including the values provided. An exemplary module comprising an ion conducting tube as described herein may be a desalination module.

The summary of the invention is provided as a general introduction to some of the embodiments of the invention and is not intended to be limiting. Additional example embodiments including variations and alternative configurations of the invention are provided herein.

### BRIEF DESCRIPTION OF SEVERAL VIEWS OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 is a diagram of a pervaporation unit.

FIG. 2 shows a perspective view of an exemplary ion conducting tube comprising a spirally wrapped ion conducting membrane sheet to form a spiral wrapped ion conducting tube.

FIG. 3 shows a perspective view of an exemplary ion conducting tube comprising a longitudinally wrapped, or “cigarette wrapped” ion conducting membrane sheet to form a longitudinally wrapped ion conducting tube.

FIG. 4 shows a side view of an ion conducting tube configured over a support mandrel having apertures to allow fluid contact with the ion conducting tube.

FIG. 5 shows a cross sectional view of an exemplary ion conducting sheet comprising an ion conducting polymer and a support material.

FIG. 6 shows a cross sectional view of an exemplary ion conducting sheet comprising an ion conducting polymer and a support material.

FIG. 7 shows a cross sectional view of an exemplary spiral wrapped tube comprising ion conducting tape that is bonded together in an overlap area.

FIG. 8 shows an exemplary module comprising a plurality of ion conducting tubes, as described herein.

Corresponding reference characters indicate corresponding parts throughout the several views of the figures. The figures represent an illustration of some of the embodiments of the present invention and are not to be construed as limiting the scope of the invention in any manner. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the present invention.

### DETAILED DESCRIPTION OF THE ILLUSTRATED EMBODIMENTS

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Also, use of “a” or “an” are employed to describe elements and components described herein. This is done merely for convenience and to give a general sense of the scope of the invention. This description should be read to include one or at least one and the singular also includes the plural unless it is obvious that it is meant otherwise.

Certain exemplary embodiments of the present invention are described herein and are illustrated in the accompanying figures. The embodiments described are only for purposes of illustrating the present invention and should not be interpreted as limiting the scope of the invention. Other embodiments of the invention, and certain modifications, combinations and improvements of the described embodiments, will occur to those skilled in the art and all such alternate embodiments, combinations, modifications, improvements are within the scope of the present invention.

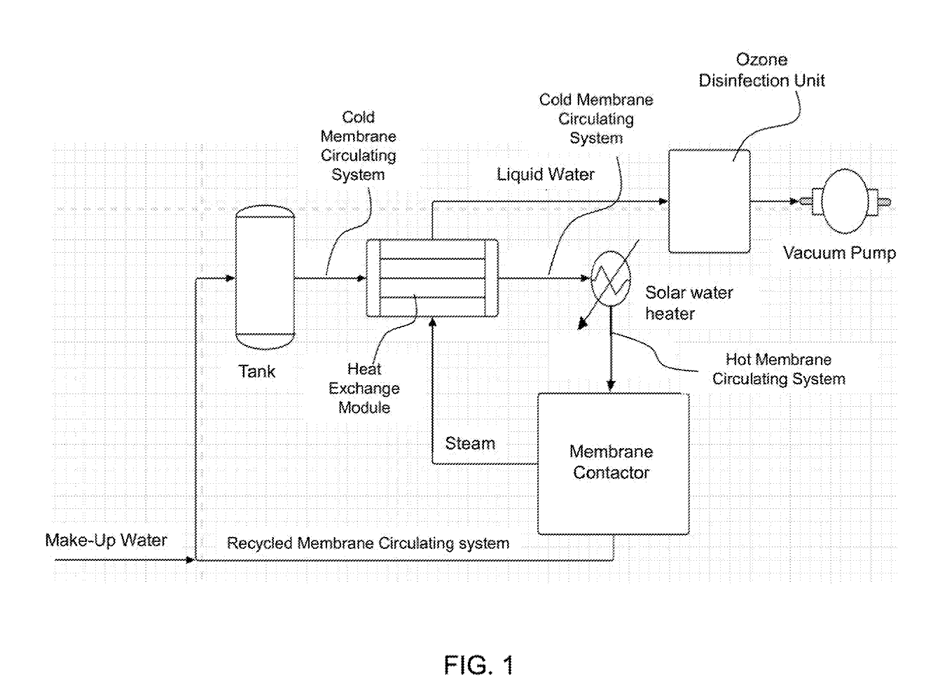

As shown in FIG. 1, an exemplary heat exchanger module which exchanges heat between the incoming cold membrane circulating stream and the steam obtained from the membrane contactor.

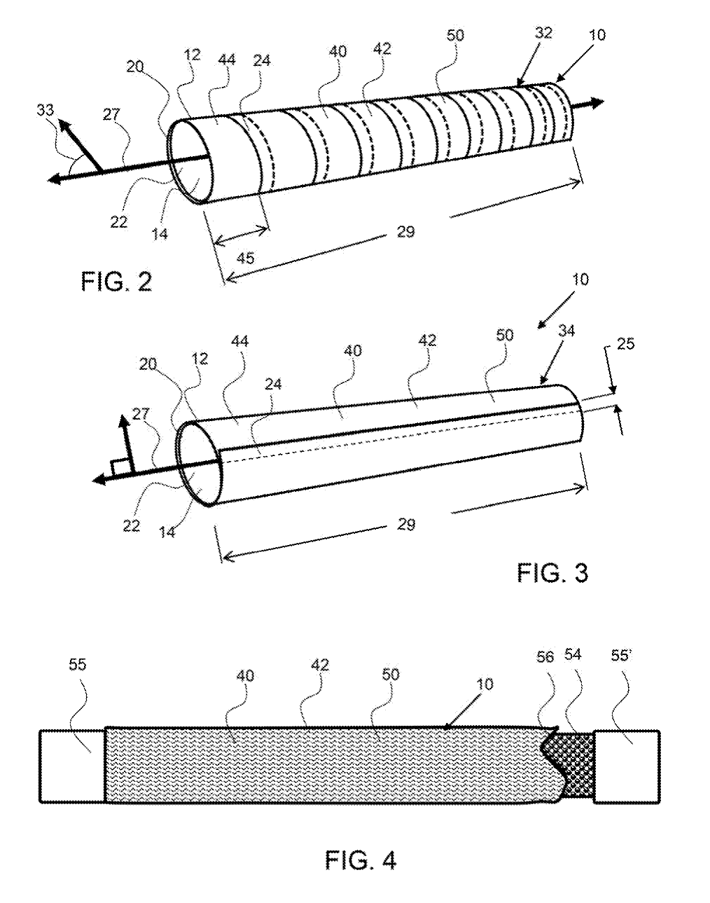

Referring to FIGS. 2 and 7, an exemplary ion conducting tube 10 comprises a spirally wrapped ion conducting membrane sheet 40, or ion conducting tape 44 to form a spiral wrapped ion conducting tube 32. The ion conducting tube 10 is has a tube wall 20 formed by the spirally wrapped ion conducting tape 44 that is wrapped at a wrap angle 33 with respect to the longitudinal axis 27 of the tube, or length axis of the tube, a line extending along the center of the tube conduit 22. An exemplary wrap angle may be 80 degrees or less, 75 degrees or less, 60 degrees or less, 45 degrees or less, 30 degrees or less and any range between and including the wrap angles provided. A smaller wrap angle may provide less overlap area and therefore better performance. The tube has an outside surface 12 and an inside surface 14, and a tube conduit 22 extending along the length 29 of the tube. The ion conducting tape 44 comprises an ion conducting polymer 42 and a support material 50, and has a width 45. The spiral wrap forms an overlap area 24 between adjacent tape wraps and this overlap area has an overlap with 25 as shown in FIG. 7. As shown in FIG. 7, the ion conducting polymer 42 of a first layer of the ion conducting tape 44 is bonded to the ion conducting polymer 42′ of a second layer of the ion conducting tape 44′ to form the bonded area 26. As described herein the overlap width may be fraction of the tape width, such as no more than about 30% of the tape width, no more than about 25% of the tape width, no more than about 20% of the tape width, no more than about 10% of the tape width, or even no more than about 5% of the tape width to provide a high percentage of the spiral wrapped tube 32 that is only a single layer, thereby increase the rate of transfer of ions through the tube. The tube wall thickness 21 is the thickness of the bonded area or both layers in the overlap area and the tube wall thickness is the thickness of a single ion conducting tape 44 otherwise.

As shown in FIG. 3, an exemplary ion conducting tube 10 comprises a longitudinally wrapped, or “cigarette wrapped” ion conducting membrane sheet 40 to form a longitudinal wrapped ion conducting tube 34. The ion conducting sheet 40 is wrapped around the longitudinal axis 27 of the tube. In this embodiment, the length of the tube 29 is the width of the ion conducting sheet and the wrap angle is perpendicular to the longitudinal axix 27. The longitudinal wrapped ion conducting tube 34 has an overlap are 25 having an overlap width 25. Again, the overlap width may be no more than about 30% of the tape width, no more than about 25% of the tape width, no more than about 20% of the tape width, no more than about 10% of the tape width, or even no more than about 5% of the tape width to provide a high percentage of the spiral wrapped tube 32 that is only a single layer, thereby increase the rate of transfer of ions through the tube.

As shown in FIG. 4, an ion conducting tube 10 is configured over a support mandrel 54 having apertures 56 to allow fluid contact with the ion conducting tube. A support mandrel may be rigid, such as a metal or plastic tube, or may be pliable and able to bend and flex. The apertures may form a substantial part of the mandrel and may be at least 50% of the area, at least 75% of the area, at least 80% of the area, at least 90% of the area, whereby the higher the aperture area percentage the higher the contact of fluid with the ion conducting tube, and therefore more ion transfer. The exemplary mandrel has adapter ends 55, 55′ that may comprise a fitting for attachment to a module frame.

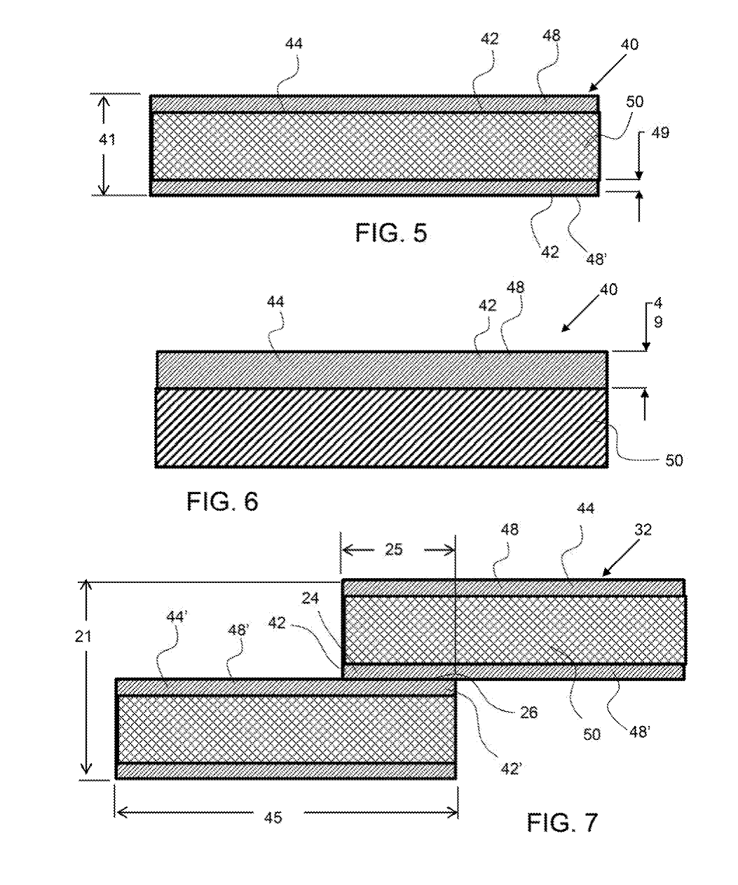

Referring now to FIGS. 5 and 6, an exemplary ion conducting sheet 40, such as an ion conducting tape 44, comprises an ion conducting polymer 42 and a support material 50 and has a single sheet thickness 41. A tape is simple a sheet that is narrow and conducive for spiral wrapping. The support material may be a porous material and the ion conducting polymer, such as an ionomer, may fill a substantial portion of the pores in the support material, such as by being imbibed into the support material. The ion conducting polymer may extends along one or both of the opposing surfaces of the composite ion conducting sheet as a surface layer 48 and has a surface layer thickness 49. In FIG. 5, the ion conducting polymer fills the pores of the support material and extends along both opposing surfaces. As shown in FIG. 6 the ion conducting polymer is imbibed into the support material and extends along one surface of the support material.

As shown in FIG. 7, the ion conducting layers extending along the opposing surfaces are bonded together in the overlap area 24 to form a bonded area 26 between the surface layer 48′ and surface layer 48. Note that the surface layer may extend into the support 50 to bond layers of ion conducting sheets or tapes together. A fluid tight seal may be formed by the overlap and bonded area.

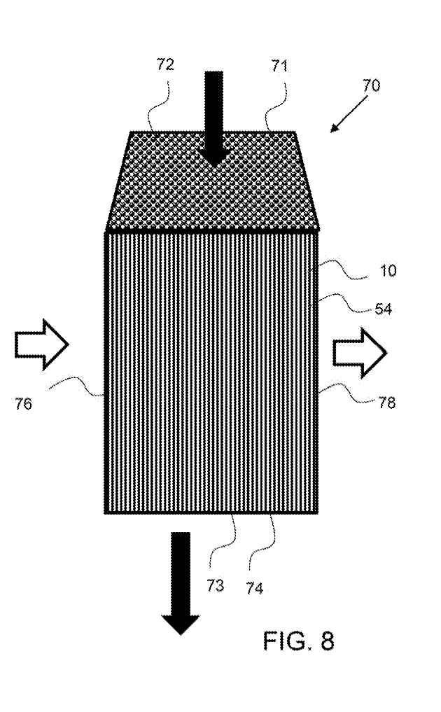

As shown in FIG. 8, an exemplary module 70 comprises a plurality of ion conducting tubes 10 that extend from a tube inlet 72 to a tube outlet 74. A flow of fluid flows through the tubes and a cross flow of fluid flow around the outside surface of the tubes from a cross-flow inlet 76 to a cross-flow outlet 78. Moisture may be transferred from or to the cross-flow fluid depending on the desired arrangement. The ion conducting tubes may be potted with potting 75 or otherwise attached to the inlet frame 71 and outlet from 73. Each tube may be configured around a mandrel 54 and the mandrel may have ends that are conducive to potting or attachment to the frame. The mandrel may have an adapter end 55 which comprises a fitting on the ends that can be secured to the frame and the adapter may have threads or beveled ends for sealing. Also note that the mandrel may have apertures along the center portion but not proximal the ends where the mandrel is attached to the frame.

It will be apparent to those skilled in the art that various modifications, combinations and variations can be made in the present invention without departing from the scope of the invention. Specific embodiments, features and elements described herein may be modified, and/or combined in any suitable manner. Thus, it is intended that the present invention cover the modifications, combinations and variations of this invention provided they come within the scope of the appended claims and their equivalents

What is claimed is:

1. An ion conducting tube comprising:
a) a composite ion conducting sheet comprising:
i) a permeable support material; and
ii) an ion conducting polymer that is coupled to the support material;
b) an overlap area formed by an outer layer of the composite ion conducting sheet over an inner layer of the composite ion conducting sheet; wherein the outer layer of the composite ion conducting sheet is attached to the inner layer of the composite ion conducting sheet in the overlap area to form said ion conducting tube;
c) a length from a first end to a second end; and
d) a tube conduit extending along said length.

2. The ion conducting tube of claim 1, wherein the thickness of the composite ion conducting sheet is no more than 25 microns.

3. The ion conducting tube of claim 1, wherein the thickness of the composite ion conducting sheet is no more than 15 microns.

4. The ion conducting tube of claim 1, wherein the tube has a tube surface area that is the product of an outer circumference of the tube and a length of the tube, and wherein the overlap area is no more than 40% of a tube surface area.

5. The ion conducting tube of claim 1, wherein the tube has a tube surface area that is the product of an outer circumference of the tube and a length of the tube, and wherein the overlap area is no more than 20% of a tube surface area.

6. The ion conducting tube of claim 4, wherein the ion conducting tube is a longitudinally wrapped tube, wherein the overlap area extends longitudinally along the length of the tube.

7. The ion conducting tube of claim 4, wherein the ion conducting tube is a spirally wrapped tube having a wrap angle of the composite ion conducting sheet around the ion conducting tube.

8. The ion conducting tube of claim 1, wherein the ion conducting polymer is a cation conducting polymer.

9. The ion conducting tube of claim 1, wherein the ion conducting polymer is an anion conducting polymer.

10. The ion conducting tube of claim 1, wherein the support material is a porous fluoropolymer having pores.

11. The ion conducting tube of claim 10, wherein the porous fluoropolymer is expanded polytetrafluorethylene.

12. The ion conducting tube of claim 1, further comprising a mandrel configured within the tube conduit.

13. The ion conducting tube of claim 1, further comprising a mandrel, and wherein the ion conducting tube is configured within the mandrel.

14. A process for making an ion conducting tube as described in claim 1 comprising:
a) wrapping the support material around a mandrel to form a wrapped mandrel;
b) coating the wrapped mandrel with the ion conducting to form the composite ion conducting sheet;
c) bonding the overlap areas to form the ion conducting tube.

15. The process of claim 14, further comprising bonding the support material together before coating the wrapped mandrel with ion conducting polymer.

16. The process of claim 14, wherein bonding the overlap areas includes heating the composite ion conducting sheet.

17. The process of claim 14, further comprising swelling the ion conducting polymer and removing the ion conducting tube from the mandrel.

18. A process for making an ion conducting tube as described in claim 1 comprising:
a) wrapping the composite ion conducting sheet around a mandrel to form a wrapped mandrel;
b) then, bonding the composite ion conducting sheet together to form the ion conducting tube.

19. The process of claim 18, further comprising removing the ion conducting tube from the mandrel.

20. The process of claim 18, further comprising swelling the ion conducting polymer and removing the ion conducting tube from the mandrel.
